(19) United States
(12) Patent Application Publication
(10) Pub. No.: US 2022/0048328 A1
(43) Pub. Date: Feb. 17, 2022

(54) PNEUMATIC RADIAL TIRE

(71) Applicant: The Yokohama Rubber Co., LTD., Tokyo (JP)

(72) Inventors: Asuka SUZUKI, Kanagawa (JP); Shinya HARIKAE, Kanagawa (JP)

(21) Appl. No.: 17/310,129

(22) PCT Filed: Dec. 18, 2019
(86) PCT No.: PCT/JP2019/049672

§ 371 Date: Jul. 19, 2021

(30) Foreign Application Priority Data
Jan. 24, 2019 (JP) 2019-010086

(51) Int. Cl. B60C 9/22; B60C 9/00; D07B 1/06; D02G 3/48

(52) U.S. Cl. CPC B60C 9/22; B60C 9/0007; B60C 9/0042; B60C 2009/2093; D02G 3/48; B60C 2009/0092; D07B 1/0633

(57) ABSTRACT

A pneumatic radial tire includes belt layers disposed on an outer circumferential side of a carcass layer in a tread portion. The belt layers are formed of steel cords in a N+M structure in which the number of wire strands N of an inner layer is 2 to 4 and the number of wire strands M of an outer layer is 2 to 7. A twist direction of the inner layer is different from a twist direction of the outer layer. The steel cords are inclined with respect to a tire circumferential direction to intersect each other in layers of the belt layers. A belt cover layer disposed on an outer circumferential side of the belt layers is formed of organic fiber cords having elongation of 2.0% to 4.0% under 2.0 cN/dtex load. The organic fiber cords are wound spirally along the tire circumferential direction.

### TECHNICAL FIELD

The present technology relates to a pneumatic radial tire provided with a belt cover layer formed of organic fiber cords and particularly relates to a pneumatic radial tire that can effectively reduce road noise.

### BACKGROUND ART

In pneumatic radial tires for passenger cars or small trucks, a carcass layer is mounted between a pair of bead portions, a plurality of belt layers are disposed on an outer circumferential side of the carcass layer in a tread portion, and a belt cover layer including a plurality of organic fiber cords spirally wound along a tire circumferential direction is disposed on an outer circumferential side of the belt layer. Such a belt cover layer contributes to improvement of high-speed durability.

In the related art, nylon fiber cords are mainly applied to the organic fiber cords used in the belt cover layer; however, it has been proposed to use polyethylene terephthalate fiber cords (hereinafter referred to as PET fiber cords) that are highly elastic and inexpensive compared to nylon fiber cords (for example, see Japan Unexamined Patent Publication No. 2001-063312). In particular, when a belt cover layer formed of such highly elastic PET fiber cords is used, the frequency of vibration generated in a pneumatic tire when traveling tends to shift into a band that is less likely to resonate with a vehicle. As a result, mid-range frequency road noise can be effectively suppressed. On the other hand, it has been revealed that the belt cover layer (highly elastic PET fiber cords) does not suppress the occurrence of vibration generated when traveling, and thus when the once generated vibration remains without sufficient dampening, a driver may feel that road noise is not reduced. As a result, there is a need for a countermeasure for improving not only road noise performance based on instrument measurements but also an impression given to a driver (road noise performance based on sensory measurements).

### SUMMARY

The present technology provides a pneumatic radial tire provided with a belt cover layer formed of organic fiber cords, the pneumatic radial tire being capable of providing road noise performance based on instrument measurements and road noise performance based on sensory measurements in a highly compatible manner.

A pneumatic radial tire according to an embodiment of the present technology includes: a tread portion extending in a tire circumferential direction and having an annular shape; a pair of sidewall portions disposed on both sides of the tread portion; and a pair of bead portions disposed on an inner side of the sidewall portions in a tire radial direction. The pneumatic radial tire includes: a carcass layer mounted between the pair of bead portions; a plurality of belt layers disposed on an outer circumferential side of the carcass layer in the tread portion; and a belt cover layer disposed on an outer circumferential side of the belt layers. The belt layers are formed of steel cords in a N+M structure in which the number of wire strands N of an inner layer is 2 to 4 and the number of wire strands M of an outer layer is 2 to 7, and in which a twist direction of the inner layer is different from a twist direction of the outer layer. The steel cords are arranged inclined with respect to the tire circumferential direction to intersect each other in layers of the belt layers. The belt cover layer is formed of organic fiber cords having elongation of 2.0% to 4.0% under 2.0 cN/dtex load. The organic fiber cords are wound spirally along the tire circumferential direction.

In an embodiment of the present technology, by using the organic fiber cords having elongation of 2.0% to 4.0% under 2.0 cN/dtex load in the belt cover layer, the frequency of vibration generated at the pneumatic tire when traveling can be shifted to a band that is less likely to resonate with a vehicle, and road noise performance based on instrument measurements can be improved. On the other hand, according to the knowledge of the present inventors, steel cords having the structure described above have characteristics that the attenuation rate of vibration is high. Accordingly, by configuring the belt layer with such steel cords, vibration of the tread portion can be effectively attenuated, and road noise performance based on sensory measurements can also be improved.

In an embodiment of the present technology, a steel cord amount A calculated as the product of a cross-sectional area S (mm²) of the steel cords and a cord count E of the steel cords per 50 mm width orthogonal to a longitudinal direction of the steel cord (the number of cords per 50 mm) is preferably within a range of 6.0 to 9.0. Accordingly, the structure of the belt layer is appropriately set, and thus road noise performance based on instrument measurements and road noise performance based on sensory measurements are advantageously provided in a compatible manner.

In an embodiment of the present technology, a ratio P2/P1 of a twisting pitch P2 of the outer layer to a twisting pitch P1 of the inner layer of the steel cords is preferably 1.0 or less. Accordingly, the structure of the steel cords is appropriately set, and thus road noise performance based on instrument measurements and road noise performance based on sensory measurements are advantageously provided in a compatible manner.

In an embodiment of the present technology, the organic fiber cords are preferably formed of polyester fibers. By using the polyester fibers as just described, road noise performance (in particular, road noise performance based on instrument measurements) can be effectively increased by excellent physical properties (high elastic modulus) of the polyester fibers.

### BRIEF DESCRIPTION OF DRAWINGS

FIG. 1 is a meridian cross-sectional view illustrating a pneumatic radial tire according to an embodiment of the present technology.

FIG. 2 is an explanatory diagram schematically illustrating a structure of steel cords.

### DETAILED DESCRIPTION

Configurations of embodiments of the present technology will be described in detail below with reference to the accompanying drawings.

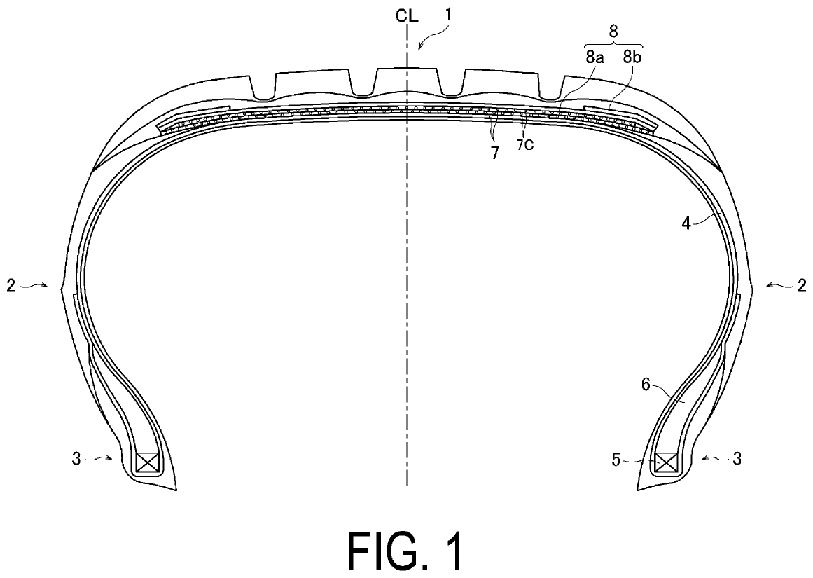

As illustrated in FIG. 1, a pneumatic tire of an embodiment of the present technology includes a tread portion 1, a pair of sidewall portions 2 disposed on both sides of the tread portion 1, and a pair of bead portions 3 disposed in the sidewall portions 2 at an inner side in a tire radial direction. Note that “CL” in FIG. 1 denotes a tire equator. Although not illustrated in FIG. 1 as FIG. 1 is a meridian cross-sectional view, the tread portion 1, the sidewall portions 2, and the bead portions 3 each extend in a tire circumferential direction to form an annular shape. Thus, a toroidal basic structure of the pneumatic tire is configured. Although the description using FIG. 1 is basically based on the illustrated meridian cross-sectional shape, all of the tire components each extend in the tire circumferential direction and form the annular shape.

In the illustrated example, a plurality of main grooves (four main grooves in the illustrated example) extending in the tire circumferential direction are formed in the outer surface of the tread portion 1; however, the number of main grooves is not particularly limited. Further, in addition to the main grooves, various grooves and sipes that include lug grooves extending in a tire width direction can be formed.

A carcass layer 4 including a plurality of reinforcing cords extending in the tire radial direction are mounted between the pair of left and right bead portions 3. A bead core 5 is embedded within each of the bead portions 3, and a bead filler 6 having a triangular cross-sectional shape is disposed on the outer periphery of the bead core 5. The carcass layer 4 is folded back around the bead core 5 from an inner side to an outer side in the tire width direction. Accordingly, the bead core 5 and the bead filler 6 are wrapped by a body portion (a portion extending from the tread portion 1 through each of the sidewall portions 2 to each of the bead portions 3) and a folded back portion (a portion folded back around the bead core 5 of each bead portion 3 to extend toward each sidewall portion 2) of the carcass layer 4. For example, polyester fiber cords are preferably used as the reinforcing cords of the carcass layer 4.

A plurality (in the illustrated example, two layers) of belt layers 7 are embedded on an outer circumferential side of the carcass layer 4 in the tread portion 1. Each of the belt layers 7 includes a plurality of reinforcing cords 7C that are inclined with respect to the tire circumferential direction, and the belt layers 7 are arranged such that the reinforcing cords 7C intersect each other in the layers. In these belt layers 7, the inclination angle of the reinforcing cords 7C with respect to the tire circumferential direction is set in the range of, for example, 10° to 40°. Steel cords are used as the reinforcing cords 7C of the belt layer 7 (in the following description, “reinforcing cords 7C” may be referred to as “steel cords 7C”).

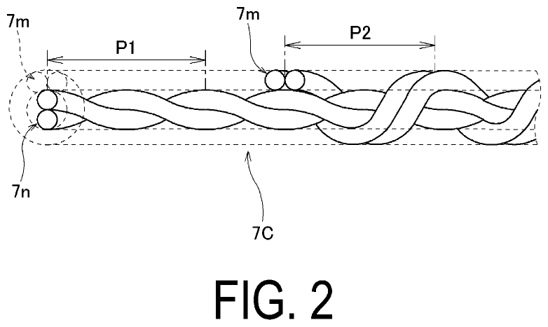

In particular, in an embodiment of the present technology, as illustrated in FIG. 2, the steel cords 7C constituting the belt layer 7 include N+M structure (in the illustrated example, 2+2 structure) that is formed of: an inner layer 7n (core) made of N wire strands; and an outer layer 7m (sheath) made of M wire strands twisted around the inner layer 7n. The number of wire strands N of the inner layer 7n is 2 to 4, and the number of wire strands M of the outer layer 7m is 2 to 7. In particular, the illustrated 2+2 structure can be suitably employed. Additionally, in an embodiment of the present technology, the twist directions of the inner layer 7n and the outer layer 7m are not identical and are different. In other words, when the inner layer 7n is S-twist, the outer layer 7m is Z-twist, and when the inner layer 7n is Z-twist, the outer layer is S-twist. When the inner layer 7n is non-twisted, the outer layer 7m is S twist or Z-twist.

A belt cover layer 8 is provided on an outer circumferential side of the belt layer 7 for the purpose of improving high-speed durability and reducing road noise. The belt cover layer 8 includes organic fiber cords oriented in the tire circumferential direction. In the belt cover layer 8, the angle of the organic fiber cords with respect to the tire circumferential direction is set, for example, to from 0° to 5°. In an embodiment of the present technology, the belt cover layer 8 necessarily includes a full cover layer 8a that covers the entire region of the belt layers 7, and can be configured to include a pair of edge cover layers 8b that locally cover both end portions of the belt layers 7 as necessary (in the illustrated example, the belt cover layer includes both the full cover layer 8a and the edge cover layers 8b). The belt cover layer 8 is preferably configured such that a strip material made of at least a single organic fiber cord bunched and covered with coating rubber is wound spirally in the tire circumferential direction, and desirably has, in particular, a jointless structure.

In particular, in an embodiment of the present technology, as the organic fiber cords constituting the belt cover layer 8, organic fiber cords having elongation of 2.0% to 4.0% under 2.0 cN/dtex load are used. The type of organic fibers constituting the organic fiber cords is not particularly limited, and for example, polyester fibers, nylon fibers, aramid fibers, or the like can be used. Out of the fibers, polyester fibers can be suitably used. Additionally, examples of the polyester fibers include polyethylene terephthalate fibers (PET fibers), polyethylene naphthalate fibers (PEN fibers), polybutylene terephthalate fibers (PBT), and polybutylene naphthalate fibers (PBN), and PET fibers can be suitably used. Note that in an embodiment of the present technology, the elongation under 2.0 cN/dtex load is an elongation ratio (%) of sample cords, which is measured under 2.0 cN/dtex load by conducting a tensile test in accordance with JIS (Japanese Industrial Standard)-L1017 “Test Methods for chemical fiber tire cords” and under the conditions that a length of specimen between grips is 250 mm and a tensile speed is 300±20 mm/minute.

As just described, the belt layer 7 formed of the steel cords 7C having a specific structure and the belt cover layer 8 formed of organic fiber cords having specific physical properties are used in combination, and thus road noise performance based on instrument measurements and road noise performance based on sensory measurements can be improved in a compatible manner. In other words, in the belt cover layer 8, due to the physical properties of the organic fiber cords, the frequency of vibration generated at the pneumatic tire when traveling can be shifted to a band that is less likely to resonate with a vehicle, and road noise performance based on instrument measurements can be improved. On the other hand, in the belt layer 7, the vibration of the tread portion 1 can be effectively attenuated due to the characteristics attributed to the structure described above (characteristics that the attenuation rate of vibration found by the present inventors is high), and road noise performance based on sensory measurements can also be improved.

At this time, when the number of wire strands N of the inner layer of the steel cords 7C constituting the belt layer 7 is less than two, the effect of fretting between the wire strands is decreased, and thus road noise performance cannot be sufficiently exhibited. When the number of wire strands N of the inner layer of the steel cords 7C constituting the belt layer 7 exceeds four, the twisted structure is not stable, and thus an initial elongation of the cords is degraded. When the number of wire strands M of the outer layer of the steel cords 7C constituting the belt layer 7 is less than two, the effect of fretting between the wire strands is decreased, and thus road noise performance cannot be sufficiently exhibited. When the number of wire strands M of the outer layer of the steel cords 7C constituting the belt layer 7 exceeds seven, the twisted structure is not stable, and thus an initial elongation of the cords is degraded. When the twist directions of the inner layer and the outer layer of the steel cords 7C constituting the belt layer 7 are identical, energy loss due to fretting between the wire strands constituting the steel cords 7C is decreased, the attenuation rate of vibration is low, and thus road noise performance based on sensory measurements cannot be sufficiently improved. When the elongation of the organic fiber cords constituting the belt cover layer 8 under 2.0 cN/dtex load is less than 2.0%, road noise performance based on sensory measurements is degraded. When the elongation of the organic fiber cords constituting the belt cover layer 8 under 2.0 cN/dtex load exceeds 4.0%, road noise performance based on instrument measurements cannot be sufficiently improved.

When the product of a cross-sectional area S (mm²) of the steel cords 7C and a cord count E of the steel cords 7C per 50 mm width orthogonal to the longitudinal direction of the steel cord 7C (the number of cords per 50 mm) is defined as a steel cord amount A, the steel cord amount A is preferably within the range of 6.0 to 9.0. Accordingly, the structure of the belt layer is appropriately set, and thus road noise performance based on instrument measurements and road noise performance based on sensory measurements are advantageously provided in a compatible manner. When the steel cord amount A is less than 6.0, although road noise performance based on instrument measurements is improved, road noise performance based on sensory measurements cannot be sufficiently ensured. When the steel cord amount A exceeds 9.0, road noise performance based on instrument measurements cannot be sufficiently improved and road noise performance based on sensory measurements cannot be sufficiently ensured. The numerical range of the cross-sectional area S or the cord count E of the steel cords 7C is not particularly limited, but the cross-sectional area S of the steel cords 7C can be set at, for example, 0.15 mm² to 0.8 mm² and the cord count E can be set at, for example, 30 cords/50 mm to 60 cords/50 mm.

In the belt layer 7, a ratio P2/P1 of a twisting pitch P2 of the outer layer 7m to a twisting pitch P1 of the inner layer 7n of the steel cords 7C is preferably 1.0 or less. Accordingly, the structure of the steel cords 7C is appropriately set, and thus road noise performance based on instrument measurements and road noise performance based on sensory measurements are advantageously provided in a compatible manner. When the ratio P2/P1 exceeds 1.0, road noise performance based on instrument measurements cannot be sufficiently improved and road noise performance based on sensory measurements cannot be sufficiently ensured. Note that when the inner layer 7n is non-twisted, the twisting pitch P1 is interpreted as “∞”, and the ratio P2/P1 in this case is regarded as “0”.

When polyethylene terephthalate fiber cords (PET fiber cords) are used as the organic fiber cords constituting the belt reinforcing layer 8, PET fiber cords having an elastic modulus in a range of 3.5 cN/(tex·%) to 5.5 cN/(tex·%) under 44N load at 100° C. are preferably used. As just described, the PET fiber cords having such characteristics of specific physical properties are used, and thus road noise based on instrument measurements can be effectively reduced while durability of the pneumatic radial tire is maintained successfully. When the elastic modulus of the PET fiber cords under 44N load at 100° C. is less than 3.5 cN/(tex·%), the mid-range frequency road noise cannot be sufficiently reduced. When the elastic modulus of the PET fiber cords under 44N load at 100° C. exceeds 5.5 cN/(tex·%), fatigue resistance of the cords decreases, and durability of the tire decreases. Note that in an embodiment of the present technology, the elastic modulus under 44N load at 100° C. [N/(tex %)] is calculated by: conducting a tensile test with reference to “Test Methods for chemical fiber tire cords” of JIS-L1017 and under the conditions that a length of specimen between grips is 250 mm and a tensile speed is 300±20 mm/minute; and converting the inclination of the tangent, at a point corresponding to load 44N of the load-elongation curve, to a value per 1 tex.

When polyethylene terephthalate fiber cords (PET fiber cords) are used as the organic fiber cords constituting the belt reinforcing layer 8, heat shrinkage stress of the PET fiber cords at 100° C. in addition is preferably 0.6 cN/tex or more. The heat shrinkage stress at 100° C. is set as just described, and thus road noise based on instrument measurements can be effectively reduced while durability of the pneumatic radial tire is maintained successfully. When the heat shrinkage stress of the PET fiber cords at 100° C. is less than 0.6 cN/tex, the hoop effect when traveling cannot be sufficiently improved, and it is difficult to sufficiently maintain high-speed durability. The upper limit value of the heat shrinkage stress of the PET fiber cords at 100° C. is not particularly limited, but is preferably, for example, 2.0 cN/tex. Note that in an embodiment of the present technology, the heat shrinkage stress (cN/tex) at 100° C. is heat shrinkage stress of a sample cord, which is measured with reference to “Test Methods for chemical fiber tire cords” of JIS-L1017 and when heated under the conditions of the sample length of 500 mm and the heating condition at 100° C. for 5 minutes.

In order to obtain the PET fiber cords having the aforementioned physical properties, for example, it is preferable to optimize dip processing. In other words, before a calendar process, dip processing with adhesive is performed on the PET fiber cords; however, in a normalizing process after a two-bath treatment, it is preferable that an ambient temperature is set within the range of 210° C. to 250° C. and cord tension is set in the range of 2.2×10⁻² N/tex to 6.7×10⁻² N/tex. Accordingly, desired physical properties as described above can be imparted to the PET fiber cords. When the cord tension in the normalizing process is smaller than 2.2×10⁻² N/tex, cord elastic modulus is low, and thus the mid-range frequency road noise cannot be sufficiently reduced. In contrast, when the cord tension is greater than 6.7×10⁻² N/tex, cord elastic modulus is high, and thus fatigue resistance of the cords is low.

### EXAMPLES

Tires according to Conventional Example 1, Comparative Examples 1 to 5, and Examples 1 to 11 were manufactured. In the tires having a tire size of 225/60R18 and including the basic structure as illustrated in FIG. 1, the structure of steel cords constituting the belt layers; the twist direction of the inner layer; the twist direction of the outer layer; the steel cord amount A calculated as the product of the cross-sectional area S of the steel cords and the cord count E of the steel cords per 50 mm width orthogonal to the longitudinal direction of the steel cord; the twisting pitch P1 of the inner layer; the twisting pitch P2 of the outer layer; the ratio P1/P2 thereof, the type of organic fibers used in the organic fiber cords that constitute the belt cover layers; and the elongation of the organic fiber cords under 2.0 cN/dtex load are differentiated as in Tables 1 and 2.

In any example, the belt cover layer includes a jointless structure in which a strip material made of at least a single organic fiber cord (nylon 66 fiber cord or PET fiber cord) bunched and covered with coating rubber is wound spirally in the tire circumferential direction. The cord count density in the strip material is 50 cords/50 mm. In addition, each organic fiber cord (nylon 66 fiber cord or PET fiber cord) has a structure of 1100 dtex/2.

For Conventional Example 1 and Comparative Example 1, in these examples, since the wire structure of the steel cords constituting the belt layers is a 1×3 structure, the twist direction and the twisting pitch are described in the column of “Inner layer” for convenience. The twisting pitch when the twist direction of the steel cords is “non-twisted” is regarded as “∞”. For the column of the type of organic fibers, nylon 66 fiber cords are indicated as “N66”, and PET fiber cords are indicated as “PET”.

As for these test tires, road noise performance based on instrument measurements and road noise performance based on sensory measurements were evaluated by the following evaluation methods, and the results are also indicated in Tables 1 and 2.

### Road Noise Performance (Instrument Measurements)

Each of the test tires was assembled on a wheel having a rim size of 18×7J, mounted as front and rear wheels of a passenger vehicle (front wheel drive vehicle) having an engine displacement of 2500 cc, and inflated to an air pressure of 230 kPa, and a sound collecting microphone was placed on an inner side of the window of a driver's seat. A sound pressure level near the frequency 315 Hz was measured when the vehicle was driven at an average speed of 50 km/h on a test course of an asphalt road surface. The evaluation results were based on Conventional Example as a reference and indicated the amount of change (dB) to the reference.

### Road Noise Performance (Sensory Measurements)

Each of the test tires was assembled on a wheel having a rim size of 18×7J, mounted as front and rear wheels of a passenger vehicle (front wheel drive vehicle) having an engine displacement of 2500 cc, and inflated to an air pressure of 230 kPa. Sensory evaluations were made by five test drivers for road noise when the vehicle was driven at an average speed of 50 km/h on a test course of an asphalt road surface. The evaluation results were scored by a 5-point method with the results of Conventional Example 1 being assigned 3-points (reference), and an average value of the scores of the three test drivers, with the exception of the highest point and the lowest point, was indicated. Larger points indicate superior road noise performance (sensory measurements).

TABLE 1-1

| | | Conventional | Comparative | Comparative | Example | Comparative |
|---|---|---|---|---|---|---|
| | | Example 1 | Example 1 | Example 2 | 1 | Example 3 |
| Belt | Structure of steel cords | 1 × 3 | 1 × 3 | 2 + 2 | 2 + 2 | 2 + 2 |
| layer | Twist direction of inner | S-twist | S-twist | Non- | Non- | S-twist |
| | layer | | | twisted | twisted | |
| | Twist direction of outer | — | — | S-twist | S-twist | S-twist |
| | layer | | | | | |
| | Steel cord amount A | 6.5 | 6.5 | 7.3 | 7.3 | 7.3 |
| | Twisting pitch P1 of mm | 14 | 14 | ∞ | ∞ | 15 |
| | inner layer | | | | | |
| | Twisting pitch P2 of mm | — | — | 15 | 15 | 15 |
| | outer layer | | | | | |
| | Ratio P1/P2 | — | — | — | 0 | 1.00 |
| Belt | Type of organic fibers | N66 | PET | N66 | PET | PET |
| cover | Elongation under 2.0% | 7.5 | 2.8 | 7.5 | 2.8 | 2.8 |
| layer | cN/dtex load | | | | | |

| | | | | | |
|---|---|---|---|---|---|
| Road noise performance dB | 0.0 | −2.0 | 0.0 | −2.0 | −2.0 |
| (instrument measurements) | | | | | |
| Road noise performance | 3.0 | 2.8 | 3.0 | 3.3 | 3.0 |
| (sensory measurements) | | | | | |

TABLE 1-2

| | | Example | Comparative | Example | Example | Comparative |
|---|---|---|---|---|---|---|
| | | 2 | Example 4 | 3 | 4 | Example 5 |
| Belt | Structure of steel cords | 2 + 2 | 2 + 2 | 2 + 2 | 2 + 2 | 2 + 2 |
| layer | Twist direction of inner | Z-twist | Non- | Non- | Non- | Non- |
| | layer | | twisted | twisted | twisted | twisted |
| | Twist direction of outer | S-twist | S-twist | S-twist | S-twist | S-twist |
| | layer | | | | | |
| | Steel cord amount A | 7.3 | 7.3 | 7.3 | 7.3 | 7.3 |
| | Twisting pitch P1 of mm | 15 | ∞ | ∞ | ∞ | ∞ |
| | inner layer | | | | | |
| | Twisting pitch P2 of mm | 15 | 15 | 15 | 15 | 15 |
| | outer layer | | | | | |
| | Ratio P1/P2 | 1.00 | 0 | 0 | 0 | 0 |
| Belt | Type of organic fibers | PET | PET | PET | PET | PET |
| cover | Elongation under 2.0% | 2.8 | 1.8 | 2.2 | 3.8 | 4.3 |
| layer | cN/dtex load | | | | | |

| | | | | | |
|---|---|---|---|---|---|
| Road noise performance dB | −2.0 | −2.5 | −2.3 | −1.5 | 0.8 |
| (instrument measurements) | | | | | |
| Road noise performance (sensory | 3.2 | 3.0 | 3.2 | 3.2 | 3.0 |
| measurements) | | | | | |

TABLE 2

| | | Example | Example | Example | Example | Example | Example | Example |
|---|---|---|---|---|---|---|---|---|
| | | 5 | 6 | 7 | 8 | 9 | 10 | 11 |
| Belt | Structure of steel cords | 2 + 2 | 2 + 2 | 2 + 2 | 2 + 2 | 2 + 2 | 2 + 2 | 2 + 2 |
| layer | Twist direction of inner | Non- | Non- | Non- | Non- | Non- | Z-twist | Z-twist |
| | layer | twisted | twisted | twisted | twisted | twisted | | |
| | Twist direction of outer | S-twist | S-twist | S-twist | S-twist | S-twist | S-twist | S-twist |
| | layer | | | | | | | |
| | Steel cord amount A | 5.5 | 6.5 | 8.5 | 9.5 | 7.3 | 7.3 | 7.3 |
| | Twisting pitch P1 of mm | ∞ | ∞ | ∞ | ∞ | ∞ | 20 | 15 |
| | inner layer | | | | | | | |
| | Twisting pitch P2 of mm | 15 | 15 | 15 | 15 | 15 | 15 | 20 |
| | outer layer | | | | | | | |
| | Ratio P1/P2 | 0 | 0 | 0 | 0 | 0 | 0.75 | 1.33 |
| Belt | Type of organic fibers | PET | PET | PET | PET | PET | PET | PET |
| cover | Elongation under | 3.0 | 3.0 | 3.0 | 3.0 | 3.0 | 3.0 | 3.0 |
| layer | 2.0% cN/dtex load | | | | | | | |

| | | | | | | | |
|---|---|---|---|---|---|---|---|
| Road noise performance dB | −2.0 | −1.8 | −1.6 | −1.4 | −1.8 | −1.7 | −1.6 |
| (instrument measurements) | | | | | | | |
| Road noise performance | 3.2 | 3.3 | 3.3 | 3.2 | 3.3 | 3.3 | 3.2 |
| (sensory measurements) | | | | | | | |

As can be seen from Tables 1 and 2, in contrast to Conventional Example 1 as the reference, the tires of Examples 1 to 11 provide both improved road noise performance based on instrument measurements and improved road noise performance based on sensory measurements. On the other hand, in Comparative Example 1, although PET fiber cords having appropriate elongation under 2.0 cN/dtex load are used as the belt cover layer, the wire structure of the steel cords constituting the belt layer is a 1×3 structure, and thus road noise performance based on sensory measurements is deteriorated. In Comparative Example 2, although the steel cords constituting the belt layer are appropriate, elongation of the belt cover layer under 2.0 cN/dtex load is too large, and thus the effect of improving both noise performance based on instrument measurements and road noise performance based on sensory measurements is not attained. In Comparative Example 3, the twist directions of the inner layer and the outer layer of the steel cords are identical, and thus the effect of improving road noise performance based on sensory measurements is not attained. In Comparative Example 4, elongation of the belt cover layer under 2.0 cN/dtex load is too small, and thus the effect of improving road noise performance based on sensory measurements is not attained. In Comparative Example 5, elongation of the belt cover layer under 2.0 cN/dtex load is too large, and thus the effect of improving both road noise performance based on instrument measurements and road noise performance based on sensory measurements is not attained.

1. A pneumatic radial tire, comprising:
a tread portion extending in a tire circumferential direction and having an annular shape;
a pair of sidewall portions disposed on both sides of the tread portion; and
a pair of bead portions disposed on an inner side of the sidewall portions in a tire radial direction,
the pneumatic radial tire comprising: a carcass layer mounted between the pair of bead portions; a plurality of belt layers disposed on an outer circumferential side of the carcass layer in the tread portion; and a belt cover layer disposed on an outer circumferential side of the belt layers,
the belt layers being formed of steel cords in a N+M structure in which a number of wire strands N of an inner layer is 2 to 4 and a number of wire strands M of an outer layer is 2 to 7, and in which a twist direction of the inner layer is different from a twist direction of the outer layer, the steel cords being arranged inclined with respect to the tire circumferential direction to intersect each other in layers of the belt layers, and
the belt cover layer being formed of organic fiber cords having elongation of 2.0% to 4.0% under 2.0 cN/dtex load, the organic fiber cords being wound spirally along the tire circumferential direction.

2. The pneumatic radial tire according to claim 1, wherein a steel cord amount calculated as a product of a cross-sectional area (mm²) of the steel cords and a cord count of the steel cords per 50 mm width orthogonal to a longitudinal direction of the steel cords (a number of cords per 50 mm) is within a range of 6.0 to 9.0.

3. The pneumatic radial tire according to claim 1, wherein a ratio P2/P1 of a twisting pitch P2 of the outer layer to a twisting pitch P1 of the inner layer of the steel cords is 1.0 or less.

4. The pneumatic radial tire according to claim 1, wherein the organic fiber cords are formed of polyester fibers.

5. The pneumatic radial tire according to claim 2, wherein a ratio P2/P1 of a twisting pitch P2 of the outer layer to a twisting pitch P1 of the inner layer of the steel cords is 1.0 or less.

6. The pneumatic radial tire according to claim 5, wherein the organic fiber cords are formed of polyester fibers.
